(19) United States
(12) Patent Application Publication
(10) Pub. No.: US 2022/0044845 A1
(43) Pub. Date: Feb. 10, 2022

(54) CABLE CLIP AND METHOD OF USE

(71) Applicant: TEK Solutions Inc., Ramsey, MN (US)

(72) Inventor: Ryan Reddy, Coon Rapids, MN (US)

(21) Appl. No.: 17/395,072

(22) Filed: Aug. 5, 2021

Related U.S. Application Data
(60) Provisional application No. 63/062,684, filed on Aug. 7, 2020.

(51) Int. Cl. H01B 7/36; F16L 3/02; G09F 3/20; G09F 3/04

(52) U.S. Cl. CPC H01B 7/368; G09F 3/04; G09F 3/205; F16L 3/02

(57) ABSTRACT

Various examples disclosed relate to a cable clip. The cable clip includes a curved body including a polymeric material and extending from a first end to a second end, the first end and second end spaced from each other to define a gap therebetween. The curved body includes a first surface and an opposed second surface with a thickness of the clip defined therebetween.

### PRIORITY

This application claims the benefit of priority to U.S. Provisional Patent Application Ser. No. 63/062,684, filed Aug. 7, 2020, which is incorporated by reference herein in its entirety.

### BACKGROUND

Cables and wires can be deployed in a variety of assemblies and systems. Where a plurality of cables and wires are present, it can be difficult to quickly identify a particular cable or wire and associate it with its function. There is therefore a need to aid a person seeking to identify a cable or wire.

### SUMMARY OF THE INVENTION

Various examples disclosed relate to a cable clip. The cable clip includes a curved body including a polymeric material and extending from a first end to a second end, the first end and second end spaced from each other to define a gap therebetween. The curved body includes a first surface and an opposed second surface with a thickness of the clip defined therebetween.

Various examples disclosed relate to a method of making a cable clip. The method includes extruding the cable clip. The cable clip includes a curved body including a polymeric material and extending from a first end to a second end, the first end and second end spaced from each other to define a gap therebetween. The curved body includes a first surface and an opposed second surface with a thickness of the clip defined therebetween.

Various examples disclosed relate to a method of making a cable clip. The method includes forming the cable clip through injection molding. The cable clip includes a curved body including a polymeric material and extending from a first end to a second end, the first end and second end spaced from each other to define a gap therebetween. The curved body includes a first surface and an opposed second surface with a thickness of the clip defined therebetween.

Various examples disclosed relate to a cable or wire. The cable or wire includes a cable clip removably attached thereto. The cable clip includes a curved body including a polymeric material and extending from a first end to a second end, the first end and second end spaced from each other to define a gap therebetween. The curved body includes a first surface and an opposed second surface with a thickness of the clip defined therebetween.

### BRIEF DESCRIPTION OF THE FIGURES

The drawings illustrate generally, by way of example, but not by way of limitation, in accordance with various examples of the present invention.

FIG. 1 is an end view of a cable clip, in accordance with various examples.

FIGS. 2A and 2B are perspective views of the cable clip of FIG. 1, rotated 180 degrees with respect to each other, in accordance with various examples of the present invention.

FIG. 3 is a perspective view of a cable including a plurality of the cable clips attached thereto, in accordance with various examples of the present invention.

### DETAILED DESCRIPTION OF THE INVENTION

Reference will now be made in detail to certain examples of the disclosed subject matter, examples of which are illustrated in part in the accompanying drawings. While the disclosed subject matter will be described in conjunction with the enumerated claims, it will be understood that the exemplified subject matter is not intended to limit the claims to the disclosed subject matter.

Throughout this document, values expressed in a range format should be interpreted in a flexible manner to include not only the numerical values explicitly recited as the limits of the range, but also to include all the individual numerical values or sub-ranges encompassed within that range as if each numerical value and sub-range is explicitly recited. For example, a range of “about 0.1% to about 5%” or “about 0.1% to 5%” should be interpreted to include not just about 0.1% to about 5%, but also the individual values (e.g., 1%, 2%, 3%, and 4%) and the sub-ranges (e.g., 0.1% to 0.5%, 1.1% to 2.2%, 3.3% to 4.4%) within the indicated range. The statement “about X to Y” has the same meaning as “about X to about Y,” unless indicated otherwise. Likewise, the statement “about X, Y, or about Z” has the same meaning as “about X, about Y, or about Z,” unless indicated otherwise.

In this document, the terms “a,” “an,” or “the” are used to include one or more than one unless the context clearly dictates otherwise. The term “or” is used to refer to a nonexclusive “or” unless otherwise indicated. The statement “at least one of A and B” has the same meaning as “A, B, or A and B.” In addition, it is to be understood that the phraseology or terminology employed herein, and not otherwise defined, is for the purpose of description only and not of limitation. Any use of section headings is intended to aid reading of the document and is not to be interpreted as limiting; information that is relevant to a section heading may occur within or outside of that particular section.

In the methods described herein, the acts can be carried out in any order without departing from the principles of the disclosure, except when a temporal or operational sequence is explicitly recited. Furthermore, specified acts can be carried out concurrently unless explicit claim language recites that they be carried out separately. For example, a claimed act of doing X and a claimed act of doing Y can be conducted simultaneously within a single operation, and the resulting process will fall within the literal scope of the claimed process.

The term “about” as used herein can allow for a degree of variability in a value or range, for example, within 10%, within 5%, or within 1% of a stated value or of a stated limit of a range, and includes the exact stated value or range.

The term “substantially” as used herein refers to a majority of, or mostly, as in at least about 50%, 60%, 70%, 80%, 90%, 95%, 96%, 97%, 98%, 99%, 99.5%, 99.9%, 99.99%, or at least about 99.999% or more, or 100%.

The term “alkyl” as used herein refers to substituted and unsubstituted straight chain and branched alkyl groups and cycloalkyl groups having from 1 to 40 carbon atoms, 1 to about 20 carbon atoms, 1 to 12 carbons or, in some embodiments, from 1 to 8 carbon atoms. Examples of straight chain alkyl groups include those with from 1 to 8 carbon atoms such as methyl, ethyl, n-propyl, n-butyl, n-pentyl, n-hexyl, n-heptyl, and n-octyl groups. Examples of branched alkyl groups include, but are not limited to, isopropyl, iso-butyl, sec-butyl, t-butyl, neopentyl, isopentyl, and 2,2-dimethylpropyl groups. As used herein, the term “alkyl” encompasses n-alkyl, isoalkyl, and anteisoalkyl groups as well as other branched chain forms of alkyl. Representative substituted alkyl groups can be substituted one or more times with any of the groups listed herein, for example, amino, hydroxy, cyano, carboxy, nitro, thio, alkoxy, and halogen groups.

The term “cycloalkyl” as used herein refers to substituted and unsubstituted cyclic alkyl groups such as, but not limited to, cyclopropyl, cyclobutyl, cyclopentyl, cyclohexyl, cycloheptyl, and cyclooctyl groups. In some embodiments, the cycloalkyl group can have 3 to about 8-12 ring members, whereas in other embodiments the number of ring carbon atoms range from 3 to 4, 5, 6, or 7. In some embodiments, cycloalkyl groups can have 3 to 6 carbon atoms (C3-C6). Cycloalkyl groups further include polycyclic cycloalkyl groups such as, but not limited to, norbornyl, adamantyl, bornyl, camphenyl, isocamphenyl, and carenyl groups, and fused rings such as, but not limited to, decalinyl, and the like.

The term “aryl” as used herein refers to substituted and unsubstituted cyclic aromatic hydrocarbon groups that do not contain heteroatoms in the ring. Thus aryl groups include, but are not limited to, phenyl, azulenyl, heptalenyl, biphenyl, indacenyl, fluorenyl, phenanthrenyl, triphenylenyl, pyrenyl, naphthacenyl, chrysenyl, biphenylenyl, anthracenyl, and naphthyl groups. In some embodiments, aryl groups contain about 6 to about 14 carbons in the ring portions of the groups. Aryl groups can be unsubstituted or substituted, as defined herein. Representative substituted aryl groups can be mono-substituted or substituted more than once, such as, but not limited to, a phenyl group substituted at any one or more of 2-, 3-, 4-, 5-, or 6-positions of the phenyl ring, or a naphthyl group substituted at any one or more of 2- to 8-positions thereof.

The terms “halo,” “halogen,” or “halide” group, as used herein, by themselves or as part of another substituent, mean, unless otherwise stated, a fluorine, chlorine, bromine, or iodine atom.

The term “alkoxy” as used herein refers to an oxygen atom connected to an alkyl group, including a cycloalkyl group, as are defined herein. Examples of linear alkoxy groups include but are not limited to methoxy, ethoxy, propoxy, butoxy, pentyloxy, hexyloxy, and the like. Examples of branched alkoxy include but are not limited to isopropoxy, sec-butoxy, tert-butoxy, isopentyloxy, isohexyloxy, and the like. Examples of cyclic alkoxy include but are not limited to cyclopropyloxy, cyclobutyloxy, cyclopentyloxy, cyclohexyloxy, and the like. An alkoxy group can include about 1 to about 12, about 1 to about 20, or about 1 to about 40 carbon atoms bonded to the oxygen atom, and can further include double or triple bonds, and can also include heteroatoms. For example, an allyloxy group or a methoxyethoxy group is also an alkoxy group within the meaning herein, as is a methylenedioxy group in a context where two adjacent atoms of a structure are substituted therewith.

The term “arylene” as used herein refers to divalent groups that are derived by removing two hydrogen atoms from an arene, which is a cyclic aromatic hydrocarbon, having from 6 to 18 carbon atoms, 10 to 18 carbon atoms, 12 to 18 carbon atoms, 6 to about 10 carbon atoms or 6 to 8 carbon atoms. Examples of (C₆-C₁₈)arylene groups include:

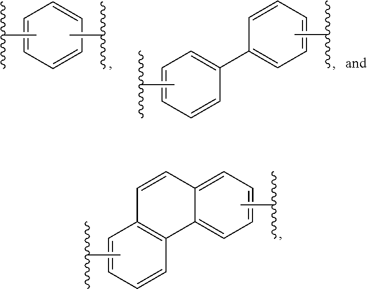

wherein the wavy lines represent the points of attachment to, e.g., —(C₁-C₆)-alkylene group.

The term “arylalkyl” as used herein refers to alkyl groups as defined herein in which a hydrogen or carbon bond of an alkyl group is replaced with a bond to an aryl group as defined herein.

The term “heteroaryl” as used herein refers to aromatic ring compounds containing 5 or more ring members, of which, one or more is a heteroatom such as, but not limited to, N, O, and S; for instance, heteroaryl rings can have 5 to about 8-12 ring members.

The term “substituted” as used herein refers to a group that can be or is substituted onto a molecule. Examples of substituents include, but are not limited to, a halogen (e.g., F, Cl, Br, and I); an oxygen atom in groups such as hydroxy groups, alkoxy groups, aryloxy groups, aralkyloxy groups, oxo(carbonyl) groups, carboxyl groups including carboxylic acids, carboxylates, and carboxylate esters; a sulfur atom in groups such as thiol groups, alkyl and aryl sulfide groups, sulfoxide groups, sulfone groups, sulfonyl groups, and sulfonamide groups; a nitrogen atom in groups such as amines, hydroxyamines, nitriles, nitro groups, N-oxides, hydrazides, azides, and enamines; and other heteroatoms in various other groups. Non-limiting examples of substituents include F, Cl, Br, I, OR, OC(O)N(R)₂, CN, NO, NO₂, ONO₂, azido, CF₃, OCF₃, R, O (oxo), S (thiono), C(O), S(O), methylenedioxy, ethylenedioxy, N(R)₂, SR, SOR, SO₂R, SO₂N(R)₂, SO₃R, C(O)R, C(O)C(O)R, C(O)CH₂C(O)R, C(S)R, C(O)OR, OC(O)R, C(O)N(R)₂, OC(O)N(R)₂, C(S)N(R)₂, (CH₂)₀₋₂N(R)C(O)R, (CH₂)₀₋₂N(R)N(R)₂, N(R)N(R)C(O)R, N(R)N(R)C(O)OR, N(R)N(R)CON(R)₂, N(R)SO₂R, N(R)SO₂N(R)₂, N(R)C(O)OR, N(R)C(O)R, N(R)C(S)R, N(R)C(O)N(R)₂, N(R)C(S)N(R)₂, N(COR)COR, N(OR)R, C(═NH)N(R)₂, C(O)N(OR)R, and C(═NOR)R, wherein R can be hydrogen or a carbon-based moiety; for example, R can be hydrogen, alkyl, acyl, cycloalkyl, aryl, aralkyl, heterocyclyl, heteroaryl, or heteroarylalkyl; or wherein two R groups bonded to a nitrogen atom or to adjacent nitrogen atoms can together with the nitrogen atom or atoms form a heterocyclyl. The term “acyl” as used herein refers to a group containing a carbonyl moiety wherein the group is bonded via the carbonyl carbon atom.

The term “aralkyl” as used herein refers to alkyl groups as defined herein in which a hydrogen or carbon bond of an alkyl group is replaced with a bond to an aryl group as defined herein. Representative aralkyl groups include benzyl and phenylethyl groups and fused (cycloalkylaryl)alkyl groups such as 4-ethyl-indanyl.

The term “heterocyclyl” as used herein refers to aromatic and non-aromatic ring compounds containing three or more ring members, of which one or more is a heteroatom such as, but not limited to, N, O, and S.

The term “heteroaryl” as used herein refers to aromatic ring compounds containing 5 or more ring members, of which, one or more is a heteroatom such as, but not limited to, N, O, and S; for instance, heteroaryl rings can have 5 to about 8-12 ring members. A heteroaryl group is a variety of a heterocyclyl group that possesses an aromatic electronic structure.

The term “heteroarylalkyl” as used herein refers to alkyl groups as defined herein in which a hydrogen or carbon bond of an alkyl group is replaced with a bond to a heteroaryl group as defined herein.

The term “number-average molecular weight” (Mₙ) as used herein refers to the ordinary arithmetic mean of the molecular weight of individual molecules in a sample. It is defined as the total weight of all molecules in a sample divided by the total number of molecules in the sample. Experimentally, Mₙ is determined by analyzing a sample divided into molecular weight fractions of species i having nᵢ molecules of molecular weight Mᵢ through the formula Mₙ=ΣMᵢnᵢ/Σnᵢ. The Mₙ can be measured by a variety of well-known methods including gel permeation chromatography, spectroscopic end group analysis, and osmometry. If unspecified, molecular weights of polymers given herein are number-average molecular weights.

The term “weight-average molecular weight” (M_{w}), which is equal to ΣMᵢ²nᵢ/ΣMᵢnᵢ, where nᵢ is the number of molecules of molecular weight Mᵢ. In various examples, the weight-average molecular weight can be determined using light scattering, small angle neutron scattering, X-ray scattering, and sedimentation velocity.

Described herein are various clips that can be removably attached to a cable or wire. The clips descried are outdoor rated, resistant to ultraviolet radiation, and can be made in a variety of colors and sizes, which can be helpful to aid in cable identification on cell sites. The clip's design allows for quick, one-handed installation with no additional tools required. Once installed, the clip can be easily adjusted multiple times or removed with ease. Additionally, the design of the clip allows for installation over factory labels. This is due to the gap left in the clip opening once installed. Additionally, the clip will not become substantially loose from the cable or wire to which it is attached due to natural thermal expansion.

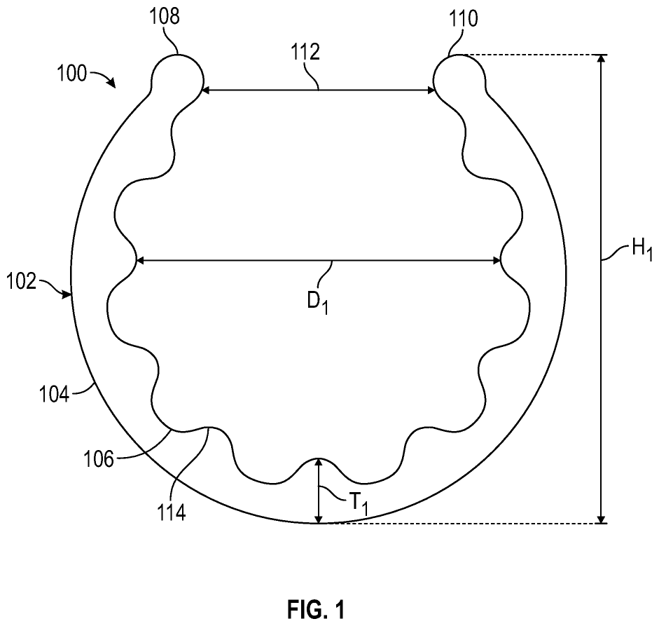

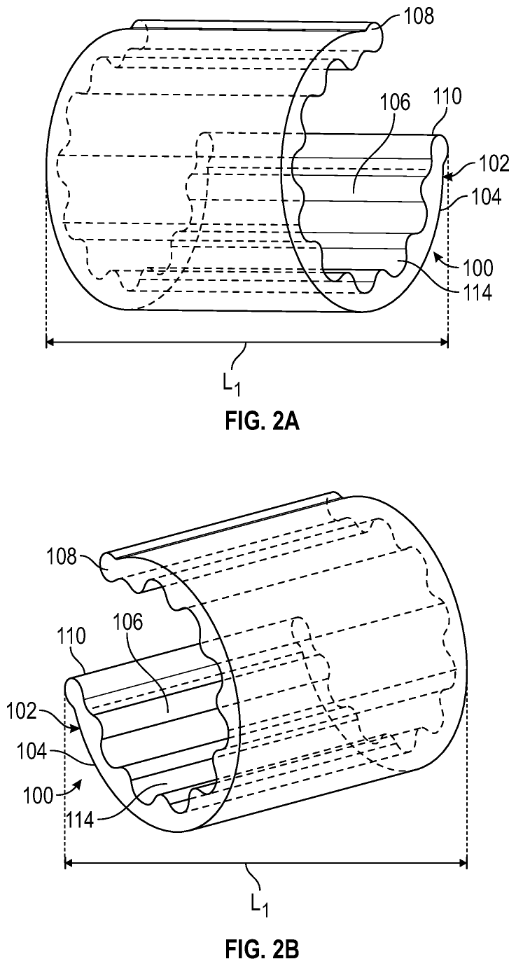

FIG. 1 is an end view of cable clip 100. FIGS. 2A and 2B are perspective views of cable clip 100 rotated at 180 degrees relative to each other. FIGS. 1, 2A, and 2B show many of the same features and are discussed concurrently. Cable clip 100, includes curved body 102. Curved body 102 is defined between first (external) surface 104 and second (internal) surface 106. A thickness (Ti) of cable clip 100 is defined by the largest value between first surface 104 and second surface 106. Curved body 102 extends between first end 108 and second end 110. Gap 112 is defined between first end 108 and second end 110. A major diameter Di of cable clip 100 is defined in curved body between opposed projections 114.

As shown, curved body 102, conforms to a generally cylindrical shape. Examples of suitable cylindrical shapes can include a right cylindrical shape, an oblique cylindrical shape, or a combination thereof. Generally, the shape of curved body 102 will be substantially commensurate with the shape of the cable or wire to which cable clip 100 is attached. Diameter Di can be generally commensurate with the major diameter of the cable or wire to which cable clip 100 is attached. For example, diameter Di can be in a range of about 10 mm to about 30 mm, about 15 mm to about 20 mm, less than, equal to, or greater than about 10 mm, 11, 12, 13, 14, 15, 16, 17, 18, 19, 20, 21, 22, 23, 24, 25, 26, 27, 28, 29, or about 30 mm. Gap 112 can have a major dimension that is less that the major dimension of the cable or wire to which cable clip 100 is attached. However, to help slide cable clip 100 over the cable or wire through gap 112, first end 108, second end 110, or both can include a rounded tip as shown in FIGS. 1, 2A, and 2B. A rounded tip on first end 108, second end 110, or both can be helpful to allow the cable or wire to catch first end 108 and second end 110 and exert force onto ends 108 and 110 such that curved body expands so that the width of gap 112 is equal to or greater than the major diameter of the cable or wire, allowing the cable or wire to enter curved body 102. The rounded shape of first end 108, second end 110, or both can be substantially cylindrical.

The rounded shape of first end 108, second end 110, or both can further be helpful to substantially prevent damage to the cable or wire when cable clip 100 is attached. This is because the rounded shape is substantially free of sharp or jagged features that could partially or fully cut the wire or cable.

Even though the width of gap 112 is less than the major diameter of the cable or wire, the width can be specifically designed to be greater than a width of a label located on the cable or wire. With this design it is possible to position cable clip 100 in such a manner that a label affixed to the cable or wire is at least partially disposed within gap 112. With the label being at least partially disposed in the gap it is possible for the label to be read, or if the label includes a bar code or QR code, those codes can be read by a scanner.

To help position cable clip 100 on the cable or wire, second surface 106 can include an undulating surface. The undulating surface includes a plurality of projections 114. Each of projections 114 extends in a direction substantially perpendicular to a line tangent to first surface 104. As shown, adjacent projections of the plurality of projections are evenly spaced with respect to each other. However, in some examples of the present disclosure, it is possible for projections 114 to be unevenly spaced with respect to each other. Cable clip 100 can include as few as one projection 114 or any plural number of projections 114. Adjacent projections 114 can have substantially the same major dimeson (e.g., height) or they can have different major dimensions.

The rounded profile of individual projections 114 can be beneficial in at least several respects. For example, the rounded profile can help to facilitate rotation of cable clip 100 on the cable or wire. This can help to position gap 112 in a desirable location relative to any labels affixed to the cable or wire. Additionally, the longitudinal profile of the projections (see, e.g., FIGS. 2A and 2B can help to allow cable clip 100 to side along the length of the cable or wire as desired. However, undesired longitudinal movement, rotational movement, or both can be negated by retention force of cable clip 100 biased against the cable or wire being at such a value that movement of cable clip 100 can only be accomplished through an application of force that is sufficient to overcome the retention force. In some examples the amount of force applied to overcome the retention force may be greater than the forces that cable clip 100 could reasonably be expected to be exposed to in operation, when removably secured to the wire or cable.

The height (H₁) of cable clip 100 can be in a range of from about 10 mm to about 30 mm, about 15 mm to about 20 mm, less than, equal to, or greater than about 10 mm, 11, 12, 13, 14, 15, 16, 17, 18, 19, 20, 21, 22, 23, 24, 25, 26, 27, 28, 29, or about 30 mm. The length (L₁) of cable clip 100 can be in a range of from about 10 mm to about 30 mm, about 15 mm to about 20 mm, less than, equal to, or greater than about 10 mm, 11, 12, 13, 14, 15, 16, 17, 18, 19, 20, 21, 22, 23, 24, 25, 26, 27, 28, 29, or about 30 mm. The exact dimensions (e.g., width, described above, height, and length) of cable clip 100 can depend on the major dimension of the cable or wire that cable clip 100 is removably secured to. For example cables or wires that cable clip 100 can be removably secured to can have a major dimension in a range of from about 5 mm to about 25 mm, about 14 mm to about 18 mm, less than, equal to, or greater than about 5 mm, 6, 7, 8, 9, 10, 11, 12, 13, 14, 15, 16, 17, 18, 19, 20, 21, 22, 23, 24, or about 25 mm.

Cable clip 100 is formed, at least in part, from a polymeric material. The polymeric material in conjunction with the physical design of cable clip 100 can impart several beneficial physical properties to cable clip 100. For example, cable clip 100 can be substantially resistant to degradation caused by ultraviolet radiation. For example, cable clip 100 can be resistant to suffering breakdown in its physical strength during prolonged exposure to ultraviolet radiation. Additionally, cable clip 100, can be substantially resistant to discoloration caused by exposure to ultraviolet radiation. For example, a yellowing index value of cable clip 100 or a material of cable clip 100, can be at a suitable value for use in outdoor applications. Yellowing Index (YI) can be determined under accelerated aging conditions (QUV) by the test method ASTM D-1925. The test result is given in hours of light exposure after aging in a QUV Accelerated Weathering Tester with QVA 351 lamps. The cycle is 4 hours dark, 8 hours light. The change in yellowness was measured on an XL-835 colorimeter from Pacific Scientific Gardner Laboratory.

The retention force of cable clip 100 can be in a range of from about 10 N to about 50 N, about 18 N to about 24 N, less than, equal to, or greater than about 10 N, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, or about 50 N. The retention force is the amount of force required to pull cable clip 100 off of a cable when pulling on cable clip 100 in a perpendicular direction from the cable. The retention force of cable clip 100 can be substantially maintained over the course of a plurality of cycles where it is removably secured and detached from the cable or wire. For example, the retention force of cable clip 100 can be substantially maintained even when cable clip 100 has been removably secured at least 50 times, at least 200 times, in a range of from about 10 times to about 500 times, about 50 times to 300 times, about 50 times, to about 200 times, less than, equal to, or greater than about 10 times, 20, 30, 40, 50, 60, 70, 80, 90, 100, 110, 120, 130, 140, 150, 160, 170, 180, 190, 200, 210, 220, 230, 240, 250, 260, 270, 280, 290, 300, 310, 320, 330, 340, 350, 360, 370, 380, 390, 400, 410, 420, 430, 440, 450, 460, 470, 480, 490, or about 500 times.

Additionally, the retention force of cable clip 100 can be substantially maintained over a wide range of temperatures. For example, the retention force of cable clip 100 can be substantially maintained while being exposed to temperatures in a range of from about −50° C. to about 100° C., about −46° C. to about 85° C., less than, equal to, or greater than about −50° C., −45, −40, −35, −30, −25, −20, −15, −10, −5, 0, 5, 10, 15, 20, 25, 30, 35, 40, 45, 50, 55, 60, 65, 70, 75, 80, 85, 90, 95, or about 100° C. 48.

The physical properties of cable clip 100 can result at least in part from the material or materials that form cable clip 100. Generally, cable clip 100 includes a polymeric material or mixture of polymeric materials. Examples of suitable polymeric materials include a polymer chosen from a polyimide, a polyamide, a polyester, a polyurethane, a polysulfone, a polyketone, a polyformal, a polycarbonate, a polyether, a poly(p-phenylene oxide), a polyether imide, a polymer having a glass transition temperature greater than 200° C., a copolymer thereof, or a mixture thereof. In specific examples the polymer can include a branched polymer, a polymer blend, a copolymer, a random copolymer, a block copolymer, a cross-linked polymer, a blend of a cross-linked polymer with a non-crosslinked polymer, a macrocycle, a supramolecular structure, a polymeric ionomer, a dynamic cross-linked polymer, a liquid-crystal polymer, a sol-gel, or a mixture thereof. In some examples the polymeric material is free of a polypropylene. In some specific examples the polymeric material is a polycarbonate.

The polycarbonate can include a polymer or copolymer having repeating structural carbonate units of Formula I:

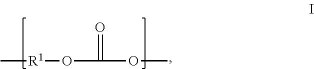

wherein at least 60 percent of the total number of R¹ groups are aromatic, or each R¹ contains at least one C₆₋₁₀ aryl group. Each R¹ group can be the same or different. Specifically, each R¹ can be derived from a dihydroxy compound such as an aromatic dihydroxy compound of Formula II or a bisphenol of Formula III.

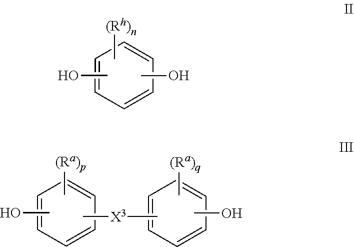

In Formula II, each R^{h} can be independently, a carbonyl group, a cyano group, an isocyanate groups, alkenyls a halogen group, for example bromine, a C₁₋₁₀ group such as a C₁₋₁₀ alkyl, a halogen-substituted C₁₋₁₀ alkyl, a C₆₋₁₀ aryl, or a halogen-substituted C₆₋₁₀ aryl, and n is 0 to 4. Suitable carbonyl groups comprise an ester, a carboxylic acid, and combinations thereof.

In Formula III R^{a} and R^{b} are each independently a halogen, C₁₋₁₂ alkoxy, or C₁₋₁₂ alkyl, and p and q are each independently integers of 0 to 4, such that when p or q is less than 4, the valence of each carbon of the ring is filled by hydrogen. In an example, p and q is each 0, or p and q is each 1, and R^{a} and R^{b} are each a C₁₋₃ alkyl group, specifically methyl, disposed meta to the hydroxy group on each arylene group. X³ is a bridging group connecting the two hydroxy-substituted aromatic groups, where the bridging group and the hydroxy substituent of each C₆ arylene group are disposed ortho, meta, or para (specifically para) to each other on the C₆ arylene group, for example, a single bond, —O—, —S—, —S(O)—, —S(O)₂—, —C(O)—, or a C₁₋₁₈ alkyl group, which can be cyclic or acyclic, aromatic or non-aromatic, and can further comprise heteroatoms such as halogens, oxygen, nitrogen, sulfur, silicon, or phosphorous. For example, X′ can be a substituted or unsubstituted C₃₋₁₈ cycloalkenyl; a C₁₋₂₅ alkylidene of the formula —C(R^{c})(R^{d})— wherein R^{c} and R^{d} are each independently hydrogen, C₁₋₁₂ alkyl, C₁₋₁₂ cycloalkyl, C₇₋₁₂ arylalkyl, C₁₋₁₂ heteroalkyl, or cyclic C₇₋₁₂ heteroarylalkyl; or a group of the formula —C(═R^{e})— wherein R^{e} is a divalent C₁₋₁₂ hydrocarbon group.

In some examples, the polycarbonate contains carbonate units (1) and non-carbonate units, for example ester units, polysiloxane units such as polydimethylsiloxane units, or a combination comprising at least one of the foregoing. In some examples the ester units can be aromatic ester units (e.g., resorcinol terephthalate or isophthalate), or aromatic-aliphatic esters.

In some examples, the polycarbonate is a linear homopolymer containing bisphenol A carbonate units (BPA-PC), commercially available under the trade name LEXAN from SABIC; or a branched, cyanophenol end-capped bisphenol A homopolycarbonate produced via interfacial polymerization, containing 3 mol % 1,1,1-tris(4-hydroxyphenyl)ethane (THPE) branching agent, commercially available under the trade name LEXAN CFR from SABIC. A specific copolycarbonate includes bisphenol A and bulky bisphenol carbonate units, e.g., derived from bisphenols containing at least 12 carbon atoms, for example 12 to 60 carbon atoms or 20 to 40 carbon atoms. Examples of such copolycarbonates include copolycarbonates comprising bisphenol A carbonate units and 2-phenyl-3,3′-bis(4-hydroxyphenyl) phthalimidine carbonate units (a BPA-PPPBP copolymer, commercially available under the trade name XHT from SABIC), a copolymer comprising bisphenol A carbonate units and 1,1-bis(4-hydroxy-3-methylphenyl)cyclohexane carbonate units (a BPA-DMBPC copolymer commercially available under the trade name DMC from SABIC), and a copolymer comprising bisphenol A carbonate units and 1,1-bis(4-hydroxy-3-methylphenyl)-3,3,5-trimethylcyclohexane isophorone bisphenol carbonate units (available, for example, under the trade name APEC from Bayer).

Other specific polycarbonates that can be used include poly(aromatic ester-carbonate)s comprising bisphenol A carbonate units and isophthalate-terephthalate-bisphenol A ester units, also commonly referred to as poly(carbonate-ester)s (PCE) or poly(phthalate-carbonate)s (PPC), depending on the relative ratio of carbonate units and ester units. Another specific poly(ester-carbonate) comprises resorcinol isophthalate and terephthalate units and bisphenol A carbonate units, such as those commercially available under the trade name LEXAN SLX from SABIC.

In another example, the polycarbonate is a poly(carbonate-siloxane) copolymer comprising bisphenol A carbonate units and siloxane units, for example blocks containing 5 to 200 dimethylsiloxane units, such as those commercially available under the trade name EXL from SABIC. Other polycarbonates that can be used include poly(ester-siloxane-carbonate)s comprising bisphenol A carbonate units, isophthalate-terephthalate-bisphenol A ester units, and siloxane units, for example blocks containing 5 to 200 dimethylsiloxane units, such as those commercially available under the trade name FST from SABIC.

Poly(aliphatic ester-carbonate)s can be used, such as those comprising bisphenol A carbonate units and sebacic acid-bisphenol A ester units, such as those commercially available under the trade name LEXAN HFD from SABIC.

Combinations of polycarbonates with other polymers can be used, for example an alloy of bisphenol A polycarbonate with an ester such as poly(butylene terephthalate) or poly(ethylene terephthalate), each of which can be semicrystalline or amorphous. Such combinations are commercially available under the trade name XENOY and XYLEX from SABIC.

The bisphenol polycarbonate repeating units can be derived from many different bisphenols. Suitable bisphenols comprise those selected from the group of 1,1-bis(4-hydroxyphenyl)methane, 1,1-bis(4-hydroxyphenyl)ethane, 2,2-bis(4-hydroxyphenyl)butane, 2,2-bis(4-hydroxyphenyl)octane, 1,1-bis(4-hydroxyphenyl)propane, 1,1-bis(4-hydroxyphenyl)-n-butane, 2,2-bis(4-hydroxy-1-methylphenyl)propane, 4,4′-dihydroxybiphenyl, bis(4-hydroxyphenyl)methane, bis(4-hydroxyphenyl)diphenylmethane, 1,2-bis(4-hydroxyphenyl)ethane, 1,1-bis(4-hydroxyphenyl)-1-phenylethane, 2-(4-hydroxyphenyl)-2-(3-hydroxyphenyl)propane, bis(4-hydroxyphenyl)phenylmethane, 1,1-bis(hydroxyphenyl)cyclopentane, 1,1-bis(4-hydroxyphenyl)cyclohexane, 1,1-bis(4-hydroxyphenyl)isobutene, 1,1-bis(4-hydroxyphenyl)cyclododecane, trans-2,3-bis(4-hydroxyphenyl)-2-butene, 2,2-bis(4-hydroxyphenyl)adamantine, (alpha,alpha′-bis(4-hydroxyphenyl)toluene, bis(4-hydroxyphenyl)acetonitrile, 1,1-dichloro-2,2-bis(4-hydroxyphenyl)ethylene, 1,1-dibromo-2,2-bis(4-hydroxyphenyl)ethylene, 3,3-bis(4-hydroxyphenyl)-2-butanone, 1,6-bis(4-hydroxyphenyl)-1,6-hexanedione, ethylene glycol bis(4-hydroxyphenyl)ether, bis(4-hydroxyphenyl)ether, bis(4-hydroxyphenyl)sulfide, bis(4-hydroxyphenyl)sulfoxide, bis(4-hydroxyphenyl)sulfone, 9,9-bis(4-hydroxyphenyl)fluorine, 2-phenyl-3,3-bis-(4-hydroxyphenyl) phthalimidine (PPPBP), 2,2-bis(4-hydroxy-3-bromophenyl)propane, 2,2-bis(3-methyl-4-hydroxyphenyl)propane, 2,2-bis(3-ethyl-4-hydroxyphenyl)propane, 2,2-bis(3-n-propyl-4-hydroxyphenyl)propane, 2,2-bis(3-isopropyl-4-hydroxyphenyl)propane, 2,2-bis(3-sec-butyl-4-hydroxyphenyl)propane, 2,2-bis(3-t-butyl-4-hydroxyphenyl)propane, 2,2-bis(3-cyclohexyl-4-hydroxyphenyl)propane, 2,2-bis(3-allyl-4-hydroxyphenyl)propane, 2,2-bis(3-methoxy-4-hydroxyphenyl)propane, 2,2-bis(4-hydroxyphenyl)hexafluoropropane, 1,1-dichloro-2,2-bis(5-phenoxy-4-hydroxyphenyl)ethylene, bis-(4-hydroxyphenyl)diphenylmethane), bis(4-hydroxydiphenyl)methane, 2,2-bis(4-hydroxy-3-isopropyl-phenyl)propane, 5,5′-(1-methylethyliden)-bis[1,1′-(bisphenyl)-2-ol]propane, 1,1-bis(4-hydroyphenyl)-3,3,5-trimethyl-cyclohexane, 1,1-bis(4-hydroxyphenyl)-cyclohexane, 2-phenyl-3,3′-bis (4-hydroxy phenyl) phthalimidine, and combinations thereof. In specific examples the bisphenol derived repeating unit is bisphenol A (2,2-bis(4-hydroxyphenyl)propane). Because there are many different types of polycarbonate units and electrophilic-side-group containing units that can be used, there is great variety in the polycarbonate component that can be formed. One such example is shown below in which the polycarbonate repeating unit is a bisphenol A derived monomer and the electrophilic-side-group containing repeating unit is derived from ethyl 3,5 dihydroxybenzoate

Other polycarbonates include a polycarbonate available under the trade designation MAKROLON ET 3227, available from Bayer Material Science—Polycarbonates, Leverkusen, Germany. MAKROLON ET 3227 can be especially useful because it is a UV-stabilized polycarbonate.

In addition to the polymeric material, cable clip 100 can include a number of additives. For example, the polymeric material of cable clip 100 can include one or more flame retardants. flame retardant additives can range from about 0.4 wt % to about 20 wt % or from about 4 wt % to about 15 wt % of the polymeric material, relative to the total weight of the polymeric material. Some illustrative examples of flame retardants include, for example, organophosphorous compounds such as organic phosphates (including trialkyl phosphates such as triethyl phosphate, tris(2-chloropropyl)phosphate, and triaryl phosphates such as triphenyl phosphate and diphenyl cresyl phosphate, resorcinol bis-diphenylphosphate, resorcinol diphosphate, and aryl phosphate), phosphites (including trialkyl phosphites, triaryl phosphites, and mixed alkyl-aryl phosphites), phosphonates (including diethyl ethyl phosphonate, dimethyl methyl phosphonate), polyphosphates (including melamine polyphosphate, ammonium polyphosphates), polyphosphites, polyphosphonates, phosphinates (including aluminum tris(diethyl phosphinate); halogenated fire retardants such as chlorendic acid derivatives and chlorinated paraffins; organobromines, such as decabromodiphenyl ether (decaBDE), decabromodiphenyl ethane, polymeric brominated compounds such as brominated polystyrenes, brominated carbonate oligomers (BCOs), brominated epoxy oligomers (BEOs), tetrabromophthalic anyhydride, tetrabromobisphenol A (TBBPA) and hexabromocyclododecane (HBCD); metal hydroxides such as magnesium hydroxide, aluminum hydroxide, cobalt hydroxide, and hydrates of the foregoing metal hydroxide; and combinations thereof. The flame retardant can be a reactive type flame-retardant (including polyols which contain phosphorus groups, 10-(2,5-dihydroxyphenyl)-10H-9-oxa-10-phospha-phenanthrene-10-oxide, phosphorus-containing lactone-modified polyesters, ethylene glycol bis(diphenyl phosphate), neopentylglycol bis(diphenyl phosphate), amine- and hydroxyl-functionalized siloxane oligomers). These flame retardants can be used alone or in conjunction with other flame retardants.

The polymeric material itself may be resistant to ultraviolet radiation, but in some examples, the polymeric material can include an additive to increase its resistance to ultraviolet radiation. Examples of such additives can include ultraviolet absorbers, quenchers, hindered amine light stabilizers (HALS), or mixtures thereof. Ultraviolet absorbers are a type of light stabilizer that functions by competing with the chromophores to absorb ultraviolet radiation. Absorbers change harmful ultraviolet radiation into harmless infrared radiation or heat that is dissipated through the polymer matrix. Carbon black is an effective light absorber. Another ultraviolet absorber is rutile titanium oxide which is effective in the 300-400 nm range. Hydroxybenzophenone and hydroxyphenylbenzotriazole are also suitable ultraviolet stabilizers that have the advantage of being suitable for neutral or transparent applications. Hydroxyphenylbenzotriazole is not very useful in thin parts below 100 microns. Other ultraviolet absorbers include oxanilides for polyamides, benzophenones for polyvinyl chloride and benzotriazoles and hydroxyphenyltriazines for polycarbonate. Ultraviolet absorbers have the benefit of low cost but may be useful only for short-term exposure. Quenchers return excited states of the chromophores to ground states by an energy transfer process. The energy transfer agent functions by quenching the excited state of a carbonyl group formed during the photo-oxidation of a polymeric material and through the decomposition of hydroperoxides. This prevents bond cleavage and ultimately the formation of free radicals. Hindered Amine Light Stabilizers are long-term thermal stabilizers that act by trapping free radicals formed during the photo-oxidation of a polymeric material and thus limiting the photodegradation process. The ability of Hindered Amine Light Stabilizers to scavenge radicals created by ultraviolet absorption is explained by the formation of nitroxly radicals through a process known as the Denisov Cycle. Although there are wide structural differences in the Hindered Amine Light Stabilizers most share the 2,2,6,6-tetramethylpiperidine ring structure. Hindered Amine Light Stabilizers are proficient UV stabilizers for a wide range of polymeric materials. While Hindered Amine Light Stabilizers are also very effective in polyolefins, polyethylene and polyurethane they are not useful in polyvinyl chloride.

Additionally, cable clip 100 can include one or more colorants or pigments. With these colorants or pigments, cable clip 100 can be one or more colors or even form a pattern of colors. This can help to control the appearance of cable clip 100 in such a manner that the color can be associated with a specific cable or wire to which cable clip 100 is removably secured. Additionally, cable clip 100 can include one or more photoluminescent glow-in-the-dark compounds. In some examples, photoluminescent glow-in-the-dark compounds include phosphorous. This can help to locate a specific cable when the ambient light conditions are low.

In addition to, or instead of, using colors to help associate cable clip 100 with a specific cable or wire, first surface 104 can include a readable medium disposed over at least a portion of first surface 104. Examples of readable mediums include word(s), a picture, a diagram, a quick response code, a bar code, or a combination thereof.

Cable clip 100 can be formed according to various procedures. For example, the polymeric material(s) described herein can be fed into an extruder with a nozzle that has a die corresponding to the negative image of cable clip 100. The polymeric material(s) are extruded through the die to form cable clip 100. In an extrusion process it may be possible to form a cable clip precursor that is cut down into shorter segments to form individual cable clips 100. Cutting the precursor into segments can result in the regions proximate to the cut having relatively sharp edges which can partially embed into the cable or wire and help to prevent undesired movement of cable clip 100 following installation.

Cable clip 100 can also be formed using injection molding. Injection molding is a manufacturing process for producing parts by injecting molten material into a mold. In an injection molding process, the polymeric material(s) described herein are fed into a heated barrel, mixed (using a helical shaped screw), and injected into a mold cavity having a shape corresponding to the negative image of cable clip 100, where it cools and hardens to the configuration of the cavity. Beyond extrusion and injection molding, it can be possible to form cable clip 100 through compression molding or additive manufacturing.

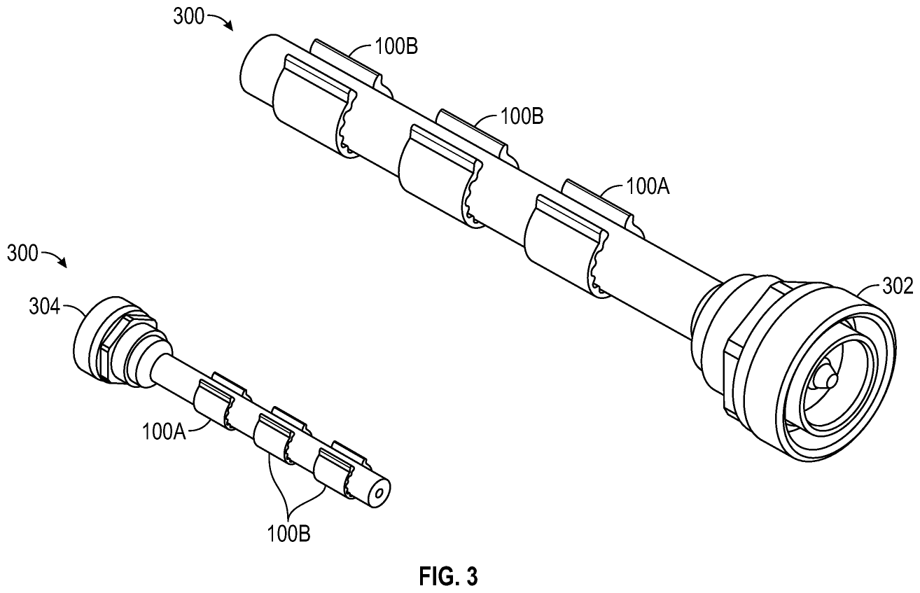

Cable clip 100 can be used in conjunction with a wide variety of cables or wires. For example, cable clip 100 can be used with a cable in a cell phone tower, a home entertainment system, a computer workstation, or server room. FIG. 3 shows cable clip 100 attached to cable 300, which is part of a cell phone tower. As shown in FIG. 3, cable 300 extends between first end 302 and second end 304. A total of six cable clips 100 are removably secured to cable 300 with three each located proximate to first end 302 and second end 304, respectively. As shown, cable clips 100A and 100B differ by color. The pattern of cable clips 100A and 100B proximate to first end 302 is the same as the pattern of cable clips 100A and 100B proximate to second end 304. Matching the patterns proximate to first end 302 and second end 304 can help a person quickly identify the ends of cable 300. This can be particularly helpful for example, if cable 300 is intermingled with a plurality of cables. Additionally, the pattern of cable clips 100A and 100B, can communicate a code to a person that indicates the cable's function (e.g., connects a transmitter to a power source). This can allow a person to quickly identify a cable that may need maintenance or replacement.

### Exemplary Examples

The following exemplary examples are provided, the numbering of which is not to be construed as designating levels of importance:

Example 1 provides a cable clip comprising a curved body comprising a polymeric material and extending from a first end to a second end, the first end and second end spaced from each other to define a gap therebetween, wherein the curved body comprises a first surface and an opposed second surface with a thickness of the clip defined therebetween.

Example 2 provides the cable clip of Example 1, wherein the curved body has a profile generally conforming to a cylindrical shape.

Example 3 provides the cable clip of any one of Examples 1-2, wherein the first end, the second end, or both comprise a rounded tip.

Example 4 provides the cable clip of Example 3, wherein the rounded tip of the first end, second end, or both comprises a substantially cylindrical shape.

Example 5 provides the cable clip of any one of Examples 3 or 4, wherein the rounded tip of the first end and the second end both comprise a substantially cylindrical shape.

Example 6 provides the cable clip of any one of Examples 1-5, wherein the second surface comprises an undulating profile.

Example 7 provides the cable clip of any one of Examples 1-6, wherein the second surface comprises a plurality of projections extending in a direction substantially perpendicular to a line tangent to the first surface.

Example 8 provides the cable clip of Example 7, wherein at least a portion of the projections comprises a rounded profile.

Example 9 provides the cable clip of any one of Examples 7 or 8, wherein each of the projections comprises a rounded profile.

Example 10 provides the cable clip of any one of Examples 7-9, wherein adjacent projections of the plurality of projections are evenly spaced with respect to each other.

Example 11 provides the cable clip of any one of Examples 7-10, wherein adjacent projections of the plurality of projections are unevenly spaced with respect to each other.

Example 12 provides the cable clip of any one of Examples 7-11, wherein the second surface comprises 10 projections spaced evenly about the second surface.

Example 13 provides the cable clip of any one of Examples 7-12, wherein a thickness of the cable clip is measured between the first surface and a tip of an individual projection.

Example 14 provides the cable clip of any one of Examples 1-13, wherein a height of the cable clip is in a range of from about 10 mm to about 30 mm.

Example 15 provides the cable clip of any one of Examples 1-14, wherein a height of the cable clip is in a range of from about 15 mm to about 20 mm.

Example 16 provides the cable clip of any one of Examples 1-15, wherein a length of the cable clip is in a range of from about 10 mm to about 30 mm.

Example 17 provides the cable clip of any one of Examples 1-16, wherein a length of the cable clip is in a range of from about 15 mm to about 20 mm.

Example 18 provides the cable clip of any one of Examples 1-17, wherein a width of the cable clip is in a range of from about 10 mm to about 30 mm.

Example 19 provides the cable clip of any one of Examples 1-18, wherein a width of the cable clip is in a range of from about 15 mm to about 20 mm.

Example 20 provides the cable clip of any one of Examples 1-19, wherein the cable clip is adapted to be removably secured to a cable having a width in a range of from about 5 mm to about 25 mm.

Example 21 provides the cable clip of any one of Examples 1-20, wherein the cable clip is adapted to be removably secured to a cable having a width in a range of from about 14 mm to about 18 mm.

Example 22 provides the cable clip of any one of Examples 1-21, wherein the cable clip is substantially resistant to degradation caused by ultraviolet radiation.

Example 23 provides the cable clip of any one of Examples 1-22, wherein the cable clip has a retention force in a range of from about 10 N to about 50 N.

Example 24 provides the cable clip of any one of Examples 1-23, wherein the cable clip has a retention force in a range of from about 18 N to about 24 N.

Example 25 provides the cable clip of any one of Examples 1-24, wherein the cable clip is adapted to be removably secured to a cable a plurality of times while substantially maintaining its retention force.

Example 26 provides the cable clip of any one of Examples 1-25, wherein the cable clip is adapted to be removably secured to a cable at least 50 times while substantially maintaining its retention force.

Example 27 provides the cable clip of any one of Examples 1-26, wherein the cable clip is adapted to be removably secured to a cable at least 200 times while substantially maintaining its retention force.

Example 28 provides the cable clip of any one of Examples 1-27, wherein the cable clip is adapted to be exposed to a temperature in a range of from about −50° C. to about 100° C. while substantially maintaining its retention force.

Example 29 provides the cable clip of any one of Examples 1-28, wherein the cable clip is adapted to be exposed to a temperature in a range of from about −46° C. to about 85° C. while substantially maintaining its retention force.

Example 30 provides the cable clip of any one of Examples 1-29, wherein the cable clip comprises one or more colors.

Example 31 provides the cable clip of any one of Examples 1-30, wherein the cable clip comprises a readable medium on the first surface.

Example 32 provides the cable clip of any one of Examples 1-31, wherein the readable medium comprises, words, a picture, a diagram, a quick response code, a bar code, or a combination thereof.

Example 33 provides the cable clip of any one of Examples 1-32, wherein the body comprises a photoluminescent glow-in-the-dark compound.

Example 34 provides the cable clip of Example 33, wherein the photoluminescent glow-in-the-dark compound comprises phosphorus.

Example 35 provides the cable clip of any one of Examples 1-34, wherein the polymeric material comprises a polymer chosen from a polyimide, a polyamide, a polyester, a polyurethane, a polysulfone, a polyketone, a polyformal, a polycarbonate, a polyether, a poly(p-phenylene oxide), a polyether imide, a polymer having a glass transition temperature greater than 200° C., a copolymer thereof, or a mixture thereof.

Example 36 provides the cable clip of Example 35, wherein the polymer is chosen from a branched polymer, a polymer blend, a copolymer, a random copolymer, a block copolymer, a cross-linked polymer, a blend of a cross-linked polymer with a non-crosslinked polymer, a macrocycle, a supramolecular structure, a polymeric ionomer, a dynamic cross-linked polymer, a liquid-crystal polymer, a sol-gel, or a mixture thereof.

Example 37 provides the cable clip of any one of Examples 35 or 36, wherein the polymer is polycarbonate.

Example 38 provides the cable clip of any one of Examples 35-37, wherein the polymeric component is free of polypropylene.

Example 39 provides the cable clip of any one of Examples 1-38, wherein the polymeric component further comprises a phosphorous-containing flame retardant additive, a halogen-containing flame retardant, a metal-hydroxide-containing flame retardant, or mixtures thereof.

Example 40 provides the cable clip of Example 39, wherein the flame retardant additive is a phosphorous-containing flame retardant comprising at least one of: an organophosphorus compound, a triraryl phosphate, a phosphite, a phosphonate, a polyphosphate, a polyphosphate, a polyphosphonate, and a phosphinate.

Example 41 provides the cable clip of any one of Examples 37-40, wherein the polycarbonate is a copolymer.

Example 42 provides the cable clip of Example 41, wherein the polycarbonate copolymer comprises an aromatic repeating unit.

Example 43 provides the cable clip of any one of Examples 41 or 42, wherein the repeating units of the polycarbonate copolymer are in random configuration

Example 44 provides the cable clip of any one of Examples 41-43, wherein the polycarbonate copolymer comprises a repeating unit comprising a bisphenol derivative.

Example 45 provides the cable clip of Example 44, wherein the bisphenol derived repeating unit is about 50 mol % to about 99 mol % of the polycarbonate copolymer.

Example 46 provides the cable clip of any one of Examples 44 or 45, wherein the bisphenol derived repeating unit is about 70 mol % to about 99 mol % of the polycarbonate copolymer.

Example 47 provides the cable clip of any one of Examples 44-46, wherein the bisphenol derived repeating unit is selected from the group consisting of 1,1-bis(4-hydroxyphenyl)methane, 1,1-bis(4-hydroxyphenyl)ethane, 2,2-bis(4-hydroxyphenyl)butane, 2,2-bis(4-hydroxyphenyl)octane, 1,1-bis(4-hydroxyphenyl)propane, 1,1-bis(4-hydroxyphenyl)-n-butane, 2,2-bis(4-hydroxy-1-methylphenyl)propane, 4,4′-dihydroxybiphenyl, bis(4-hydroxyphenyl)methane, bis(4-hydroxyphenyl)diphenylmethane, 1,2-bis(4-hydroxyphenyl)ethane, 1,1-bis(4-hydroxyphenyl)-1-phenylethane, 2-(4-hydroxyphenyl)-2-(3-hydroxyphenyl)propane, bis(4-hydroxyphenyl)phenylmethane, 1,1-bis(hydroxyphenyl)cyclopentane, 1,1-bis(4-hydroxyphenyl)cyclohexane, 1,1-bis(4-hydroxyphenyl)isobutene, 1,1-bis(4-hydroxyphenyl)cyclododecane, trans-2,3-bis(4-hydroxyphenyl)-2-butene, 2,2-bis(4-hydroxyphenyl)adamantine, (alpha,alpha′-bis(4-hydroxyphenyl)toluene, bis(4-hydroxyphenyl)acetonitrile, 1,1-dichloro-2,2-bis(4-hydroxyphenyl)ethylene, 1,1-dibromo-2,2-bis(4-hydroxyphenyl)ethylene, 3,3-bis(4-hydroxyphenyl)-2-butanone, 1,6-bis(4-hydroxyphenyl)-1,6-hexanedione, ethylene glycol bis(4-hydroxyphenyl)ether, bis(4-hydroxyphenyl)ether, bis(4-hydroxyphenyl)sulfide, bis(4-hydroxyphenyl)sulfoxide, bis(4-hydroxyphenyl)sulfone, 9,9-bis(4-hydroxyphenyl)fluorine, 2-phenyl-3,3-bis-(4-hydroxyphenyl) phthalimidine (PPPBP), 2,2-bis(4-hydroxy-3-bromophenyl)propane, 2,2-bis(3-methyl-4-hydroxyphenyl)propane, 2,2-bis(3-ethyl-4-hydroxyphenyl)propane, 2,2-bis(3-n-propyl-4-hydroxyphenyl)propane, 2,2-bis(3-isopropyl-4-hydroxyphenyl)propane, 2,2-bis(3-sec-butyl-4-hydroxyphenyl)propane, 2,2-bis(3-t-butyl-4-hydroxyphenyl)propane, 2,2-bis(3-cyclohexyl-4-hydroxyphenyl)propane, 2,2-bis(3-allyl-4-hydroxyphenyl)propane, 2,2-bis(3-methoxy-4-hydroxyphenyl)propane, 2,2-bis(4-hydroxyphenyl)hexafluoropropane, 1,1-dichloro-2,2-bis(5-phenoxy-4-hydroxyphenyl)ethylene, bis-(4-hydroxyphenyl)diphenylmethane), bis(4-hydroxydiphenyl)methane, 2,2-bis(4-hydroxy-3-isopropyl-phenyl)propane, 5,5′-(1-methylethyliden)-bis[1,1′-(bisphenyl)-2-ol]propane, 1,1-bis(4-hydroyphenyl)-3,3,5-trimethyl-cyclohexane, 1,1-bis(4-hydroxyphenyl)-cyclohexane, 2-phenyl-3,3′-bis (4-hydroxy phenyl) phthalimidine, and combinations thereof.

Example 48 provides a method of making the cable clip of any one of Examples 1-47, comprising extruding the cable clip.

Example 49 provides a method of making the cable clip of any one of Examples 1-48, wherein the cable clip is formed by injection molding.

Example 50 provides a cable, the cable comprising the cable clip of any one of Examples 1-49, removably attached thereto.

Example 51 provides the cable of Example 50 wherein the cable clip is a first cable clip and a second cable clip is attached thereto and spaced apart from the first cable clip.

Example 52 provides the cable of any one of Examples 50 or 51, wherein the cable comprises a label and the label is at least partially visible through the gap.

Example 53 provides a method of using the cable of any one of Examples 1-52, the method comprising attaching the cable clip to the cable.

Example 54 provides the method of Example 53, further comprising rotating the cable clip about the cable.

Example 55 provides the method of any one of Examples 53 or 54, further comprising removing the cable clip from the cable.

What is claimed is:

1. A cable clip comprising a curved body comprising a polymeric material and extending from a first end to a second end, the first end and second end spaced from each other to define a gap therebetween, wherein the curved body comprises a first surface and an opposed second surface with a thickness of the clip defined therebetween.

2. The cable clip of claim 1, wherein the curved body has a profile generally conforming to a cylindrical shape.

3. The cable clip of claim 1, wherein the first end, the second end, or both comprise a rounded tip.

4. The cable clip of claim 3, wherein the rounded tip of the first end, second end, or both comprises a substantially cylindrical shape.

5. The cable clip of claim 1, wherein the second surface comprises an undulating profile.

6. The cable clip of claim 1, wherein the second surface comprises a plurality of projections extending in a direction substantially perpendicular to a line tangent to the first surface.

7. The cable clip of claim 6, wherein at least a portion of the projections comprises a rounded profile.

8. The cable clip of claim 7, wherein adjacent projections of the plurality of projections are evenly spaced with respect to each other.

9. The cable clip of claim 1, wherein a length of the cable clip is in a range of from about 10 mm to about 30 mm.

10. The cable clip of claim 1, wherein a width of the cable clip is in a range of from about 10 mm to about 30 mm.

11. The cable clip of claim 1, wherein the cable clip is adapted to be removably secured to a cable having a width in a range of from about 5 mm to about 25 mm.

12. The cable clip of claim 1, wherein the cable clip has a retention force in a range of from about 10 N to about 50 N.

13. The cable clip of claim 1, wherein the cable clip is adapted to be removably secured to a cable a plurality of times while substantially maintaining its retention force.

14. The cable clip of claim 1, wherein the cable clip is adapted to be exposed to a temperature in a range of from about −50° C. to about 100° C. while substantially maintaining its retention force.

15. The cable clip of claim 1, wherein the polymeric material comprises a polymer chosen from a polyimide, a polyamide, a polyester, a polyurethane, a polysulfone, a polyketone, a polyformal, a polycarbonate, a polyether, a poly(p-phenylene oxide), a polyether imide, a polymer having a glass transition temperature greater than 200° C., a copolymer thereof, or a mixture thereof.

16. The cable clip of claim 1, wherein the polymeric component is free of polypropylene.

17. A method of making the cable clip of claim 1, comprising extruding the cable clip.

18. A method of making the cable clip of claim 1, wherein the cable clip is formed by injection molding.

19. A cable, the cable comprising the cable clip of claim 1, removably attached thereto.

20. The cable of claim 19 wherein the cable clip is a first cable clip and a second cable clip is attached thereto and spaced apart from the first cable clip and the cable comprises a label and the label is at least partially visible through the gap
